(19) United States
(12) Patent Application Publication
(10) Pub. No.: US 2026/0323676 A1
(43) Pub. Date: Oct. 15, 2026

(54) INFORMATION PROCESSING METHOD AND APPARATUS, COMMUNICATION DEVICE, AND STORAGE MEDIUM

(71) Applicant: Beijing Xiaomi Mobile Software Co., Ltd., Beijing (CN)

(72) Inventor: Shengxiang GUO, Beijing (CN)

(21) Appl. No.: 19/483,566

(22) PCT Filed: May 11, 2023
(86) PCT No.: PCT/CN2023/093692

§ 371 Date: Nov. 11, 2025

(51) Int. Cl. H04W 72/541; H04W 72/0453

(52) U.S. Cl. CPC H04W 72/541; H04W 72/0453

(57) ABSTRACT

A method for processing information, performed by a terminal, including: sending first information to a network device, where the first information is configured to indicate frequency offset information of a frequency band combination, the frequency band combination includes at least one interfered frequency band, and the frequency offset information includes at least one of a frequency offset value or a frequency offset range.

### CROSS-REFERENCE TO RELATED APPLICATION

The present application is a U.S. National Stage of International Application No. PCT/CN2023/093692, filed on May 11, 2023, the contents of all of which are incorporated herein by reference in their entirety for all purposes.

### BACKGROUND OF THE INVENTION

In the field of wireless communication technologies, a multi-carrier technology is widely applied.

### SUMMARY OF THE INVENTION

The present disclosure relates to, but is not limited to, the field of wireless communication technologies, and in particular, to a method and device for processing information, a communication device, and a storage medium.

According to a first aspect of the embodiments of the present disclosure, a method for processing information is provided. The method for processing information is performed by a terminal, and includes: sending first information to a network device, where the first information is configured to indicate frequency offset information of a frequency band combination, the frequency band combination includes at least one interfered frequency band, and the frequency offset information includes at least one of a frequency offset value or a frequency offset range.

According to a second aspect of the embodiments of the present disclosure, a method for processing information is provided. The method for processing information is performed by a network device, and includes: receiving first information sent by a terminal, where the first information is configured to indicate frequency offset information of a frequency band combination, the frequency band combination includes at least one interfered frequency band, and the frequency offset information includes at least one of a frequency offset value or a frequency offset range.

According to a third aspect of the embodiments of the present disclosure, a device for processing information is provided. The device for processing information includes: a first sending module configured to send first information to a network device, where the first information is configured to indicate frequency offset information of a frequency band combination, the frequency band combination includes at least one interfered frequency band, and the frequency offset information includes at least one of a frequency offset value or a frequency offset range.

According to a fourth aspect of the embodiments of the present disclosure, a device for processing information is provided. The device for processing information includes: a second receiving module configured to receive first information sent by a terminal, where the first information is configured to indicate frequency offset information of a frequency band combination, the frequency band combination includes at least one interfered frequency band, and the frequency offset information includes at least one of a frequency offset value or a frequency offset range.

According to a fifth aspect of the embodiments of the present disclosure, a communication device is provided. The communication device includes one or more processors, a transceiver, a memory, and an executable program stored on the memory and executable by the one or more processors. The one or more processors, when collectively running the executable program, perform the method for processing information provided by the first aspect or the second aspect.

According to a sixth aspect of the embodiments of the present disclosure, a non-transitory computer-readable storage medium is provided. The non-transitory computer-readable storage medium stores an executable program. The executable program, when collectively executed by one or more processors, implements the method for processing information provided by the first aspect or the second aspect.

### BRIEF DESCRIPTION OF DRAWINGS

The accompanying drawings are incorporated in this specification and constitute a part of this specification, show embodiments conforming to the present disclosure, and are used together with this specification to explain the embodiments of the present disclosure.

FIG. 1 is a schematic diagram of a structure of a wireless communication system according to an example.

FIG. 2 is a schematic diagram of a harmonic interference frequency offset according to an example.

FIG. 3 is a schematic diagram of a harmonic mixing interference frequency offset according to an example.

FIG. 4 is a schematic diagram of an adjacent-channel interference frequency offset according to an example.

FIG. 5 is a schematic diagram of an intermodulation interference according to an example.

FIG. 6 is a schematic flowchart of a method for processing information according to an example.

FIG. 7 is a schematic flowchart of a method for processing information according to another example.

FIG. 8 is a schematic flowchart of a method for processing information according to another example.

FIG. 9 is a schematic flowchart of a method for processing information according to another example.

FIG. 10 is a schematic flowchart of a method for processing information according to another example.

FIG. 11 is a schematic flowchart of a method for processing information according to another example.

FIG. 12 is a schematic diagram of a structure of a device for processing information according to an example.

FIG. 13 is a schematic diagram of a structure of a device for processing information according to an example.

FIG. 14 is a schematic diagram of a structure of a UE according to an example.

FIG. 15 is a schematic diagram of a structure of a communication device according to an example.

### DETAILED DESCRIPTION OF THE INVENTION

Examples are described in detail herein, and examples are presented in the accompanying drawings. When the following description relates to the accompanying drawings, unless specified otherwise, same numbers in different accompanying drawings represent a same or similar element. Implementations described in the following examples do not represent all implementations consistent with the embodiments of the present disclosure. Instead, the implementations are merely examples of devices and methods consistent with some aspects of the embodiments of the present disclosure.

The terms used in embodiments of the present disclosure are merely for the purpose of illustrating specific embodiments, and are not intended to limit the embodiments of the present disclosure. The singular expressions “a,” “an,” “the,” “the foregoing,” and “this” in the embodiments of the present disclosure also include the plural forms thereof, unless the context clearly indicates otherwise. It is also to be understood that the term “and/or” as used herein refers to and encompasses any and all possible combinations of one or more of the associated listed items. In the embodiments of the present disclosure, the term “a plurality of” refers to two or more. The prefixes “first,” “second,” and the like in the embodiments of the present disclosure are merely used to distinguish different descriptive objects and do not impose any limitation on the positions, sequences, priorities, quantities, or contents of the described objects. The statements of the described objects are interpreted in view of the context of the claims or embodiments, and no unnecessary limitation shall be construed from the use of such prefix numerals. For example, terms such as “first,” “second,” and “third” are used to describe various pieces of information, but such information is not limited to these terms. These terms are used solely to distinguish information of the same type from each other. For example, first information may also be referred to as second information, and similarly, second information may also be referred to as first information, without departing from the scope of the embodiments of the present disclosure. Depending on the context, for example, words “in a case where” used herein may be explained as “while” or “when” or “in response to determining”. In some embodiments, the names of information and the like are not limited to the names disclosed in the embodiments, and terms such as “information,” “message,” “signaling,” “report,” “indication,” “configuration,” and “data” can be used interchangeably.

In some embodiments of the present disclosure, the terms “obtain,” “acquire,” “get,” “receive,” and “transmit (send and/or receive)” are used interchangeably, which may be interpreted as receiving from another entity, obtaining from a protocol, processing internally, or other similar meanings.

In some embodiments of the present disclosure, the terms “send,” “report,” “deliver,” and “transmit (send and/or receive)” may be used interchangeably.

In the field of wireless communication technologies, a multi-carrier technology is widely applied. In a case where a multi-carrier transmission is implemented in some frequency band combinations, potential self-interference may occur. Under the self-interference, a certain frequency offset exists between a generated interfering signal and a received signal. In a case where a network device does not know the frequency offset, the network device cannot reasonably schedule resources to reduce or even avoid the impact caused by the interference.

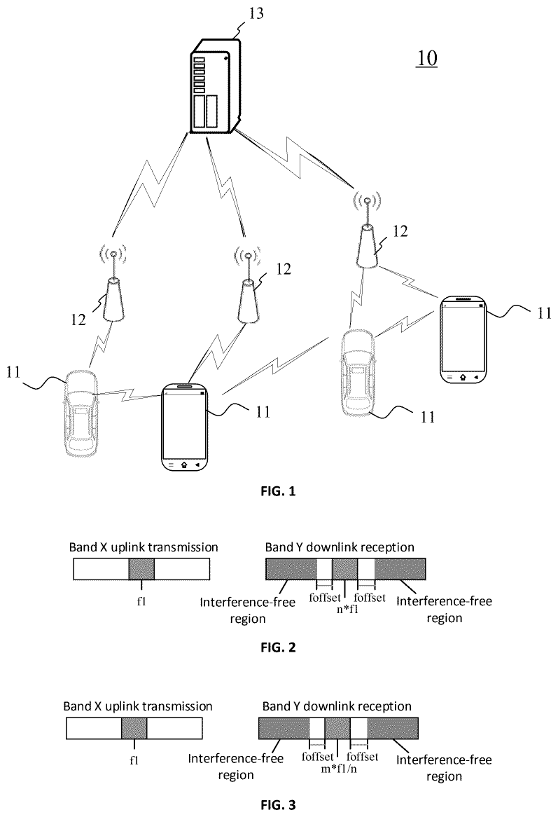

FIG. 1 is a schematic diagram of a structure of a wireless communication system according to an embodiment of the present disclosure. As shown in FIG. 1, the wireless communication system 10 is a communication system based on a cellular mobile communication technology, and may include a plurality of User Equipments (UEs) 11 and a plurality of access network elements 12.

The UE 11 may refer to a device that provides at least one of voice or data connectivity for a user. The UE 11 may communicate with one or more core networks through a Radio Access Network (RAN). The UE 11 may be an internet of things UE such as a sensor device, a mobile phone (or referred to as “cellular” phone) and a computer having the internet of things UE. For example, the UE 11 may be a fixed, portable, pocket-sized, handheld, computer-built-in or vehicle-mounted device. For example, the UE 11 may be a station (STA), a subscriber unit, a subscriber station, a mobile station, a mobile console, a remote station, an access point, a remote terminal, an access terminal, a user terminal, a user agent, or user equipment (UE). Alternatively, the UE 11 may also be a device of an unmanned aerial vehicle. Alternatively, the UE 11 may also be a vehicle-mounted device, for example, a vehicle computer with a wireless communication function, or a wireless communication device externally connected to the vehicle computer. Alternatively, the UE 11 may also be a roadside device, for example, a street lamp, a signal lamp or other roadside device having a wireless communication function.

The access network element 12 may be a network-side device in the wireless communication system 10. The wireless communication system 10 may be a 4th generation (4G) mobile communication system, which is also referred to as a Long-Term Evolution (LTE) system. Alternatively, the wireless communication system 10 may also be a 5G system, also referred to as a new radio (NR) system or a 5G NR system. Alternatively, the wireless communication system 10 may also be a next generation system of a 5G system. The access network in the 5G system may be referred to as a New Generation-Radio Access Network (NG-RAN). Alternatively, the wireless communication system 10 may be a Machine Type Communication (MTC) system.

The access network element 12 may be an evolved Node B (eNB) used in the 4G system. Alternatively, the access network element 12 may also be an access device (gNB) using a centralized-distributed architecture in the 5G system. The access network element 12 generally includes a central unit (CU) and at least two distributed units (DU) in a case of using the centralized-distributed architecture. The central unit is provided with protocol stacks for a Packet Data Convergence Protocol (PDCP) layer, a Radio Link Control (RLC) layer, and a Media Access Control (MAC) layer. The distributed unit is provided with a protocol stack for a Physical (PHY) layer. The embodiments of the present disclosure do not limit the specific implementation of the access network element 12.

A wireless connection may be established between the access network element 12 and the UE 11 through an air interface. In various embodiments, the air interface is an air interface based on a 4G mobile communication network technology standard; alternatively, the air interface is an air interface based on a fifth generation (5G) mobile communication network technology standard, for example, the air interface is a new radio; alternatively, the air interface may also be an air interface based on a next generation mobile communication network technology standard of the 5G.

In some embodiments, the wireless communication system 10 may further include a core network element 13.

Each of a plurality of access network elements 12 is connected to the core network element 13. The core network element 13 may be a core network device in the wireless communication system 10, for example, the core network element 13 may be a Mobility Management Entity (MME) in an Evolved Packet Core (EPC). Alternatively, the core network device may also be other core network devices, such as a Serving Gateway (SGW), a Public Data Network Gateway (PGW), a Policy and Charging Rules Function (PCRF), or a Home Subscriber Server (HSS). Alternatively, the core network element 13 may be a core network device in 5G, for example, a Policy Control Function (PCF), a Session Management Function (SMF), an Access and Mobility Management Function (AMF), a Unified Data Management (UDM), or a User Plane Function (UPF). The implementation form of the core network element 13 is not limited in the embodiments of the present disclosure.

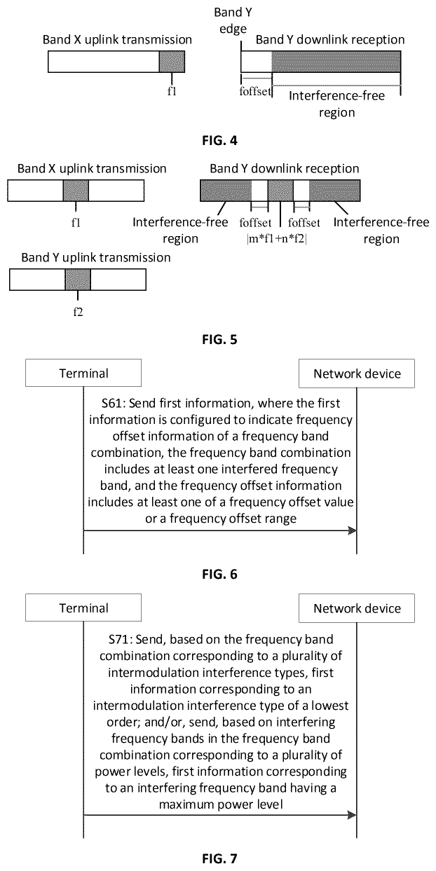

In some embodiments, in order to improve the transmission rate and the system capacity, a multi-carrier technology is widely used. For example, the multi-carrier technology is applied in Carrier Aggregation (CA) and Dual Connectivity (DC), where the DC may be Evolved Universal Terrestrial Radio Access Dual Connectivity (EN-DC), and the like. However, in a case where a multi-carrier transmission is implemented in some frequency band combinations, certain self-interference issues may occur, such as harmonic interference shown in FIG. 2, harmonic mixing interference shown in FIG. 3, adjacent-channel interference shown in FIG. 4, and intermodulation interference shown in FIG. 5. As shown in FIG. 2, a frequency band where an uplink transmission of Band X is located may be an interfering frequency band, a frequency band where a downlink reception of Band Y is located is an interfered frequency band, and the Band Y includes an interference-free region, foffset, and n*f1, where foffset is a frequency offset value, f1 is a transmitted signal, and n*f1 is a harmonic interference frequency band generated by the uplink transmission (for example, n*f1 may correspond to a bandwidth where the downlink reception signal is located). As shown in FIG. 3, a frequency band where an uplink transmission of Band X is located may be an interfering frequency band, a frequency band where a downlink reception of Band Y is located is an interfered frequency band, and the Band Y includes an interference-free region, foffset, and m*f1/n, where foffset is a frequency offset value, f1 is a transmitted signal, and m*f1/n is a harmonic mixing interference frequency band generated by the uplink transmission (for example, m*f1/n may be a bandwidth where a downlink reception signal is located). As shown in FIG. 4, a frequency band where an uplink transmission of Band X is located may be an interfering frequency band, a frequency band where a downlink reception of Band Y is located is an interfered frequency band, and the Band Y includes an interference-free region and foffset, where foffset is a frequency offset value, and f1 is a transmitted signal. As shown in FIG. 5, a frequency band where an uplink transmission of Band X is located and a frequency band where an uplink transmission of Band Y is located are interfering frequency bands, a frequency band where a downlink reception of the Band Y is located is an interfered frequency band, and the Band Y includes an interference-free region, foffset, and |m*f1+n*f2|, where foffset is a frequency offset value, f1 and f2 are transmitted signals, and |m*f1+n*f2| is an intermodulation interference frequency band generated by the uplink transmissions (for example, |m*f1+n*f2| may be a bandwidth where a downlink reception signal is located). In an example, in FIGS. 2 to 5, both m and n are integers.

In some embodiments, under maximum power transmission and in a case where a center frequency of an interfering signal is exactly aligned with a center frequency of a received signal, a maximum sensitivity loss of an interfered signal is generally expressed as Maximum Sensitivity Degradation (MSD). A larger MSD indicates a greater sensitivity loss of the received signal caused by self-interference, thereby having a more significant impact on the communication performance of multi-carrier systems. However, in practice, in a case where there is a certain frequency offset value between the generated interfering signal and the received signal, the MSD decreases sharply. A region where the MSD is very low or equal to 0 may be referred to as an interference-free region (for example, the interference-free regions corresponding to different interferences shown in FIGS. 2 to 5), and the effect of such self-interference may be neglected. Therefore, assuming that the base station can know the frequency offset value, the base station can reduce or even avoid the impact of such self-interference by scheduling different resources during deployment or allocation.

The frequency offset value is related to a radio frequency capability of the terminal, and the frequency offset value may be reported by the terminal, so that the base station may flexibly and effectively schedule resources for the terminal, thereby reducing the impact of the self-interference.

As shown in FIG. 6, an embodiment of the present disclosure provides a method for processing information. The method for processing information is performed by a terminal, and includes step S61.

In step S61, first information is sent to a network device. The first information is configured to indicate frequency offset information of a frequency band combination, the frequency band combination includes at least one interfered frequency band, and the frequency offset information includes at least one of a frequency offset value or a frequency offset range.

In some embodiments, the terminal may be, but is not limited to, the UE described in other embodiments. In an example, the terminal may be at least one of the following: a mobile phone, a computer, a server, a wearable device, a gaming console, a roadside device, an in-vehicle device, or a multimedia device. In an example, the terminal may be at least one of the following: a Reduced Capability UE (Redcap UE), a 5G NR-lite terminal, a Redcap terminal, or an eRedcap terminal.

In some embodiments, the network device may be another function or node flexibly deployed in an access network. In an example, the network device may be any type of base station. For example, the base station may be at least one of the following: a 2G base station, a 3G base station, a 4G base station, a 5G base station, or other evolved base stations.

In some embodiments, the frequency band combination includes at least one frequency band. In an example, the frequency band may be at least one of an interfering frequency band or an interfered frequency band.

In an example, the interfered frequency band includes at least one of a bandwidth where a downlink signal is located or an interference-free region, where the downlink signal is a downlink reception signal. In an example, the interfered frequency band further includes a bandwidth where the frequency offset value is located.

In an example, the interference-free region is a bandwidth in the interfered frequency band that differs from the downlink signal by the frequency offset value.

In an example, the interference-free region is a bandwidth where the MSD of the downlink signal is less than or equal to a predetermined value. The predetermined value is very low or 0.

In an example, the interference-free region is a bandwidth with minimal or no interference with the downlink signal.

In some embodiments, the terminal sends the first information to the network device.

In an example, the first information is configured to indicate a self-interference frequency offset capability. For example, the self-interference frequency offset capability may include at least one of: a frequency offset value, a frequency offset range, an interfered frequency band, an interference type, or a power level.

In an example, the first information is information related to the frequency offset value. For example, the information related to the frequency offset value may include at least one of: a frequency offset value, a frequency offset range, an interfered frequency band, an interference type, or a power level.

In an example, the first information is configured to indicate at least one of an interfered frequency band, an interference type, or a power level in the frequency band combination.

In some embodiments, the frequency offset information of the frequency band combination includes at least one of the following:
a frequency offset value of the at least one interfered frequency band in the frequency band combination; or
a frequency offset range of the at least one interfered frequency band in the frequency band combination.

In some embodiments, the frequency offset information of the frequency band combination includes at least one of the following:
a frequency offset value of an interference-free region in the interfered frequency band relative to a bandwidth edge of a downlink signal;
a frequency offset range of an interference-free region in the interfered frequency band relative to a bandwidth edge of a downlink signal;
a frequency offset value of an interference-free region in the interfered frequency band relative to a frequency band edge of an interfering frequency band, where the frequency offset value is close to the frequency band edge of the interfering frequency band; or
a frequency offset range of an interference-free region in the interfered frequency band relative to a frequency band edge of an interfering frequency band, where the frequency offset range is close to the frequency band edge of the interfering frequency band.

In some embodiments, the first information further includes at least one of the following:
interference type information, where the interference type information is configured to indicate an interference type corresponding to the frequency band combination;
frequency band indication information, where the frequency band indication information is configured to indicate the at least one interfered frequency band included in the frequency band combination; or
power level information, where the power level information is configured to indicate a power level corresponding to an interfering frequency band.

In an example, the frequency band indication information may also be configured to indicate at least one of the following: at least one interfering frequency band included in the frequency band combination; or at least one interfered frequency band included in the frequency band combination.

In an example, the interference type includes at least one of the following: a harmonic interference type, a harmonic mixing interference type, an adjacent-channel interference type, or an intermodulation interference type.

In an example, the interference type information includes one of the following: first interference type information or second interference type information. For example, the first interference type information is configured to indicate at least one of a second interference type of a predetermined order or a first interference type. The first interference type includes at least one of a harmonic interference type, a harmonic mixing interference type, or an adjacent-channel interference type. The second interference type includes an intermodulation interference type. The predetermined order is greater than 1. For example, the second interference type information is configured to indicate at least one of a first interference type or a second interference type.

In an example, the second interference type of the predetermined order includes at least one of the following: a second-order intermodulation interference type, a third-order intermodulation interference type, a fourth-order intermodulation interference type, a fifth-order intermodulation interference type, or a sixth-order intermodulation interference type, etc.

In an example, the power level may include at least one power level. In an example, different power levels may correspond to different frequency offset values. Therefore, the network device may determine the frequency offset value corresponding to the frequency band combination according to the power level.

In an example, the frequency offset value, the frequency offset range, the interference type information, the frequency band indication information, and the power level information may each be one or more bits.

In an example, the unit of at least one of the frequency offset value or the frequency offset range may be MHz or a occupied resource block (RB) size.

In an example, in a case where the frequency band combination is of a harmonic interference type, a harmonic mixing interference type, or an intermodulation interference type, the frequency offset value is configured to indicate a frequency offset value of an interference-free region of at least one interfered frequency band in the frequency band combination relative to a bandwidth edge of the downlink signal. For example, as shown in FIG. 2, n*f1 corresponds to the bandwidth of the downlink signal, and the interference-free region has a frequency offset value relative to the bandwidth edge of n*f1.

In an example, in a case where the frequency band combination is of an intermodulation interference type, the frequency offset value is configured to indicate a frequency offset value of an interference-free region in at least one interfered frequency band of the frequency band combination relative to a frequency band edge of an interfering frequency band of the frequency band combination, where the frequency offset value is close to the frequency band edge of the interfering frequency band. The frequency offset value being close to the frequency band edge of the interfering frequency band means that a distance between the frequency band where the frequency offset value is located and the frequency band edge of the interfering frequency band is less than a distance between the interference-free region and the frequency band edge of the interfering frequency band. For example, as shown in FIG. 4, in a case where the Band X is to the left of the Band Y, a frequency offset value exists between the interference-free region and the Band X, and a frequency offset value exists between the interference-free region and the left edge of the Band Y; and in a case where the Band X is to the right of the Band Y, a frequency offset value exists between the interference-free region and the right edge of the Band Y.

In an example, the frequency offset value may be represented by 2 bits, with different bits indicating different frequency offset values. For example, a frequency offset value of 1 MHz is indicated by “00”, a frequency offset value of 2 MHz is indicated by “01”, a frequency offset value of 3 MHz is indicated by “10”, and/or a frequency offset value of 4 MHz is indicated by “11”. It is to be noted that different frequency offset values may be indicated by any other bits.

In an example, in a case where the frequency band combination is of a harmonic interference type, a harmonic mixing interference type, or an intermodulation interference type, the frequency offset range is configured to indicate a frequency offset range of an interference-free region of at least one interfered frequency band in the frequency band combination relative to a bandwidth edge of the downlink signal.

In an example, in a case where the frequency band combination is of an intermodulation interference type, the frequency offset range is configured to indicate a frequency offset range of an interference-free region of at least one interfered frequency band in the frequency band combination relative to a frequency band edge of the interfering frequency band in the frequency band combination, and the frequency offset range is close to the frequency band edge of the interfering frequency band. The frequency offset range being close to the frequency band edge of the interfering frequency band means that a distance between the frequency band where the frequency offset range is located and the frequency band edge of the interfering frequency band is less than a distance between the interference-free region and the frequency band edge of the interfering frequency band.

In an example, the frequency offset range may be represented by 2 bits, with different bits indicating different frequency offset ranges. For example, as shown in Table 1, a frequency offset range greater than or equal to 5 MHz is indicated by “00”, a frequency offset range greater than or equal to 10 MHz is indicated by “01”, a frequency offset range greater than or equal to 15 MHz is indicated by “10”, and/or a frequency offset range greater than or equal to 20 MHz is indicated by “11”. It is to be noted that different frequency offset ranges may be indicated by any other bits.

TABLE 1

| 00 | 01 | 10 | 11 |
|---|---|---|---|
| ≥5 MHz | ≥10 MHz | ≥15 MHz | ≥20 MHz |

In an example, in a case where the frequency band combination includes a plurality of interfered frequency bands, different information fields in the frequency offset value or the frequency offset range may be used to respectively indicate frequency offset values or frequency offset ranges corresponding to different interfered frequency bands. For example, the frequency band combination includes three interfered frequency bands, a frequency offset value corresponding to a first interfered frequency band is indicated by a first information field in the frequency offset value, a frequency offset value corresponding to a second interfered frequency band is indicated by a second information field in the frequency offset value, and a frequency offset value corresponding to a third interfered frequency band is indicated by a third information field in the frequency offset value; and/or, a frequency offset range corresponding to a first interfered frequency band is indicated by a first information field in the frequency offset range, a frequency offset range corresponding to a second interfered frequency band is indicated by a second information field in the frequency offset range, and a frequency offset range corresponding to a third interfered frequency band is indicated by a third information field in the frequency offset range. The first information field, the second information field, and the third information field may each be one or more bits. In this way, at least one of the frequency offset values or the frequency offset ranges corresponding to the plurality of interfered frequency bands may be indicated, which is adapted to a scenario of a frequency band combination including a plurality of interfered frequency bands.

In an example, in a case where the frequency band combination includes a plurality of interfered frequency bands, a single information field in the frequency offset value may indicate frequency offset values of all the interfered frequency bands, where the frequency offset values corresponding to the plurality of interfered frequency bands are the same; and/or, in a case where the frequency band combination includes a plurality of interfered frequency bands, a single information field in the frequency offset range may indicate frequency offset ranges of all the interfered frequency bands, where the frequency offset ranges corresponding to the plurality of interfered frequency bands are the same.

In an example, the first interference type information and the second interference type information are in different bits. For example, the bits of the first interference type information are 3 bits, and the bits of the second interference type information are 2 bits.

In an example, as shown in Table 2, the interference type of the frequency band combination may be indicated through 3 bits. For example, a harmonic interference type is indicated by “000”, a harmonic mixing interference type is indicated by “001”, an adjacent-channel interference type is indicated by “010”, a second-order intermodulation interference type is indicated by “011”, a third-order intermodulation interference type is indicated by “100”, a fourth-order intermodulation interference type is indicated by “101”, a fifth-order intermodulation interference type is indicated by “110”, and/or a sixth-order intermodulation interference type is indicated by “111”.

TABLE 2

| 000 | 001 | 010 | 011 | 100 | 101 | 110 | 111 |
|---|---|---|---|---|---|---|---|
| Harmonic | Harmonic | Adjacent- | Second-order | Third-order | Fourth-order | Fifth-order | Sixth-order |
| interference | mixing | channel | intermodulation | intermodulation | intermodulation | intermodulation | intermodulation |
| type | interference | interference | interference | interference | interference | interference | interference |
| | type | type | type | type | type | type | type |

In an example, as shown in Table 3, the interference type of the frequency band combination may be indicated through 2 bits. For example, a harmonic interference type is indicated by “00”, a harmonic mixing interference type is indicated by “01”, an adjacent-channel interference type is indicated by “10”, and/or an intermodulation interference type is indicated by “11”.

TABLE 3

| 00 | 01 | 10 | 11 |
|---|---|---|---|
| Harmonic | Harmonic | Adjacent- | Intermodulation |
| interference | mixing | channel | interference |
| type | interference | interference | type |
| | type | type | |

In an example, the frequency band indication information is 2 bits, and different frequency bands may be indicated by different bits. For example, an interfered frequency band Band X1 is indicated by “00”, an interfered frequency band Band X2 is indicated by “01”, an interfered frequency band Band X3 is indicated by “10”, and/or an interfered frequency band Band X4 is indicated by “11”. It is to be noted that different interfered frequency bands may be indicated by any other bits. In an example, at least one of different interfered frequency bands or different interfering frequency bands may be indicated by any bits. In an example, in a case where the frequency band combination includes a plurality of frequency bands (for example, at least one of the interfered frequency bands or the interfering frequency bands), the plurality of frequency bands may be indicated by different information fields in the frequency band indication information.

In an example, the power level information may be 2 bits, and different power levels may be indicated by different bits. For example, a first power level is indicated by “00”, a second power level is indicated by “01”, a third power level is indicated by “10”, and/or a fourth power level is indicated by “11”. It is to be noted that different power levels may be indicated by any other bits. In an example, in a case where the frequency band combination includes a plurality of interfering frequency bands, power levels corresponding to different interfering frequency bands may be indicated by different information fields in the power level information.

It is to be understood that each element in Table 1, Table 2, or Table 3 independently exists, and these elements are listed in the same table by way of example, but this does not mean that all elements in the table needs to simultaneously exist as shown in the tables. A value of each element is independent of a value of any other element in Table 1, Table 2, or Table 3. Therefore, those skilled in the art may understand that the value of each element in Table 1, Table 2, or Table 3 is an independent embodiment.

In the embodiments of the present disclosure, the terminal sends the first information to the network device, where the first information is configured to indicate at least one of the frequency offset value or the frequency offset range of the frequency band combination, and the frequency band combination includes at least one interfered frequency band. In this way, at least one of the frequency offset value or the frequency offset range may be reported by the terminal, enabling the network device to schedule appropriate resources for transmission according to at least one of the frequency offset value or the frequency offset range to reduce the self-interference, for example, to schedule resources located in an interference-free region for transmission, so as to significantly reduce the self-interference. In other words, the network device can perform more flexible and efficient resource scheduling, thereby reducing the impact of the self-interference.

In addition, in a case where the first information includes at least one of the frequency offset value or the frequency offset range, the network device may be informed of at least one of the frequency offset value or the frequency offset range corresponding to at least one interfered frequency band in the frequency band combination.

Moreover, in a case where the first information includes at least one of the interference type information, the frequency band indication information, or the power level information, the network device may further be informed of at least one of the interference types, the interfered frequency bands or the power levels corresponding to the interfering frequency bands in the frequency band combination, thereby facilitating flexible and effective resource scheduling by the network device and further reducing the impact of the self-interference. Furthermore, in a case where the network device is informed of the power levels corresponding to the interfering frequency bands in the frequency band combination, the network device may determine the frequency offset values corresponding to the frequency band combination according to the power levels.

It is to be noted that those skilled in the art may understand that the method provided in the embodiments of the present disclosure may be executed independently or executed together with some methods in some embodiments of the present disclosure or some methods in related technologies.

In some embodiments, the first information includes the frequency offset information, and the first information does not include at least one of interference type information, frequency band indication information, or power level information; and the first information is configured to indicate frequency offset information corresponding to at least one of all interfered frequency bands, all interference types, or all power levels in the frequency band combination. In an example, the frequency offset information includes at least one of a frequency offset value or a frequency offset range.

In an example, in a case where the first information includes the frequency offset information and does not include the interference type information, the frequency offset information indicated by the first information is adapted to all interference types in the frequency band combination.

In an example, in a case where the first information includes the frequency offset information and does not include the frequency band indication information, at least one of the frequency offset value or the frequency offset range indicated by the first information is adapted to the interfered frequency band indicated by the frequency band indication information in the frequency band combination.

In an example, in a case where the first information includes at least one of the frequency offset value or the frequency offset range and does not include the power level information, the frequency offset information indicated by the first information is adapted to all power levels in the frequency band combination.

In an example, in a case where the first information includes the frequency offset information and does not include the interference type information, the frequency band indication information, and the power level information, the frequency offset information indicated by the first information is adapted to at least one of all interference types, all interfered frequency bands, or all power levels in the frequency band combination.

In the embodiments of the present disclosure, at least one of the frequency offset values or the frequency offset ranges applicable to at least one of all interference types, all interfered frequency bands, or all power levels in the frequency band combination are reported by including merely the frequency offset information in the first information and not including at least one of the interference type information, the frequency band indication information, or the power level information in the first information, thereby reducing the overhead of information that may be reported.

It is to be noted that those skilled in the art may understand that the method provided in the embodiments of the present disclosure may be executed independently or executed together with some methods in some embodiments of the present disclosure or some methods in related technologies.

In some embodiments, sending the first information includes at least one of the following:
sending, based on the frequency band combination corresponding to a plurality of intermodulation interference types, first information corresponding to an intermodulation interference type of a lowest order; or
sending, based on interfering frequency bands in the frequency band combination corresponding to a plurality of power levels, first information corresponding to an interfering frequency band having a maximum power level.

As shown in FIG. 7, an embodiment of the present disclosure provides a method for processing information. The method for processing information is performed by the terminal, and includes step S71.

In step S71, first information corresponding to an intermodulation interference type of a lowest order is sent based on the frequency band combination corresponding to a plurality of intermodulation interference types; and/or, first information corresponding to an interfering frequency band having a maximum power level is sent based on interfering frequency bands in the frequency band combination corresponding to a plurality of power levels.

In some embodiments of the present disclosure, the frequency band combination may be the frequency band combination in other embodiments; the first information may be the first information in other embodiments; and the intermodulation interference type and the power level may be the intermodulation interference type and the power level in other embodiments respectively.

In an example, sending the first information corresponding to the intermodulation interference type of the lowest order may include sending the first information corresponding to the intermodulation interference type of the lowest order to the network device; and/or, sending the first information corresponding to the interfering frequency band having the maximum power level may include sending the first information corresponding to the interfering frequency band having the maximum power level to the network device.

In an example, the first information corresponding to the intermodulation interference type of the lowest order may include at least one of the following: an interfered frequency band corresponding to the intermodulation interference type of the lowest order; at least one of a frequency offset value or a frequency offset range corresponding to the interfered frequency band; interference type indication information corresponding to the intermodulation interference type of the lowest order; or power level information corresponding to an interfering frequency band corresponding to the intermodulation interference type of the lowest order.

In an example, the first information corresponding to the interfering frequency band having the maximum power level may include at least one of the following: a maximum power level; an interfered frequency band interfered by an interfering frequency band corresponding to the maximum power level; at least one of a frequency offset value or a frequency offset range corresponding to the interfered frequency band; or interference type information of the interfering frequency band corresponding to the maximum power level.

In an example, the intermodulation interference types corresponding to the frequency band combination include a second-order intermodulation interference type, a third-order intermodulation interference type, and a fourth-order intermodulation interference type, and the terminal sends first information corresponding to the second-order intermodulation interference type to the network device. Alternatively, the intermodulation interference types corresponding to the frequency band combination include a fourth-order intermodulation interference type, a fifth-order intermodulation interference type, and a sixth-order intermodulation interference type, and the terminal sends first information corresponding to the fourth-order intermodulation interference type to the network device.

In an example, the power levels corresponding to the interfering frequency band in the frequency band combination include a first power level, a second power level, and a third power level; the power of the first power level is less than or equal to the power of the second power level, and the power of the second power level is less than or equal to the power of the third power level; and the terminal sends first information corresponding to the third power level to the network device.

In the embodiments of the present disclosure, in a case where the frequency band combination corresponds to a plurality of intermodulation interference types, the terminal may send, to the network device, the first information corresponding to the intermodulation interference type of the lowest order. Since the frequency offset value corresponding to the intermodulation interference type of the lowest order is the largest, sending the first information corresponding to the intermodulation interference type of the lowest order may enable the network device to make the downlink reception signals fall into an interference-free region as much as possible when scheduling resources for frequency band combinations corresponding to intermodulation interference types of all orders, thereby reducing the impact of the self-interference.

In an example, in a case where the frequency band combination corresponds to a plurality of power levels, the first information corresponding to the interfering frequency band having the maximum power level is merely reported. Since the frequency offset value corresponding to the interfered frequency band interfered by the interfering frequency band having the maximum power level is the largest, sending the first information corresponding to the interfering frequency band having the maximum power level may enable the network device to make the downlink reception signals fall into an interference-free region as much as possible when scheduling resources for frequency band combinations corresponding to all power levels, thereby reducing the impact of the self-interference.

It is to be noted that those skilled in the art may understand that the method provided in the embodiments of the present disclosure may be executed independently or executed together with some methods in some embodiments of the present disclosure or some methods in related technologies.

In some embodiments, sending the first information includes at least one of the following:
reporting, based on the frequency band combination including a plurality of interfered frequency bands, first information for each of different interfered frequency bands;
reporting, based on the frequency band combination corresponding to a plurality of interference types, first information for each of different interference types; or
reporting, based on interfering frequency bands included in the frequency band combination corresponding to a plurality of power levels, first information for each of different power levels.

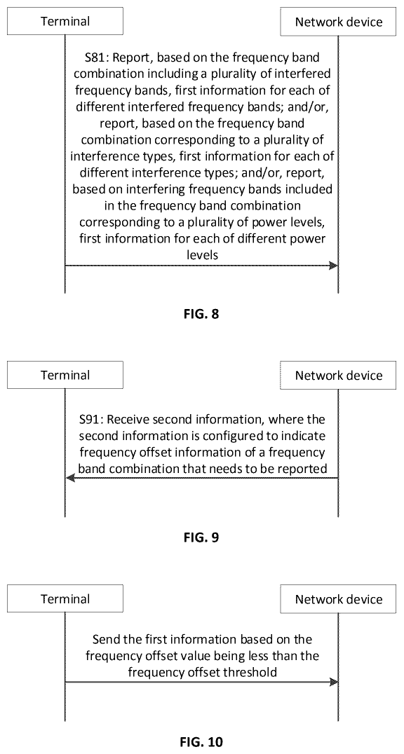

As shown in FIG. 8, an embodiment of the present disclosure provides a method for processing information. The method for processing information is performed by the terminal, and includes step S81.

In step S81, first information for each of different interfered frequency bands is reported based on the frequency band combination including a plurality of interfered frequency bands; and/or, first information for each of different interference types is reported based on the frequency band combination corresponding to a plurality of interference types; and/or, first information for each of different power levels is reported based on interfering frequency bands included in the frequency band combination corresponding to a plurality of power levels.

In some embodiments of the present disclosure, the first information may be the first information in other embodiments; the interfered frequency band, the interference type and the power level may be the interfered frequency band, the interference type and the power level in other embodiments, respectively.

In an example, reporting the first information for each of different interfered frequency bands may include sending the first information to the network device for each of the different interfering frequency bands; and/or, reporting the first information for each of different interference types may include sending the first information to the network device for each of the different interference types; and/or, reporting the first information for each of different power levels may include sending the first information to the network device for each of the different power levels.

In an example, reporting may be performed separately or together through different information. For example, the frequency band combination includes a plurality of interfered frequency bands, for example, three interfered frequency bands, and the first information corresponding to each of the three interfered frequency bands may be separately sent to the network device, or three different information fields in the first information may respectively carry first information corresponding to each of the three interfered frequency bands, and the first information carrying the three information fields may be sent to the network device.

In the embodiments of the present disclosure, the first information may be reported for each of the different interfered frequency bands, the first information may be reported for each of the different interference types, and/or the first information may be reported for each of the different power level, so that the first information corresponding to each of the interfering frequency bands, each of the interference types, and each of the power levels may be reported more accurately.

It is to be noted that those skilled in the art may understand that the method provided in the embodiments of the present disclosure may be executed independently or executed together with some methods in some embodiments of the present disclosure or some methods in related technologies.

In some embodiments, sending the first information may include: reporting first information corresponding to a frequency band combination having a predetermined number of frequency bands based on the terminal supporting the report for a frequency band combination having frequency bands greater than or equal to the predetermined number of frequency bands. The frequency band may be an interfered frequency band.

In an example, 5 Bands are taken as an example. Uplink: Band X1, Band X3. Downlink: Band X1, Band X2, Band X3, Band X4, and Band X5. Possible self-interference includes: uplink Band X1 and Band X3 interfere with downlink Band X1 and Band X3, and a reuse combination for the terminal to report the first information to the network device includes: uplink: Band X1 and Band X3; downlink: Band X1 and Band X3. Alternatively, possible self-interference includes: uplink Band X1 and Band X3 interfere with downlink Band X2, and a reuse combination for the terminal to report the first information to the network device includes: uplink: Band X1 and Band X3; downlink: Band X1, Band X2, and Band X3 (in the case of three bands, the band without an uplink is indicated as the interfered band). Alternatively, possible self-interference includes: uplink Band X1 and Band X3 interfere with downlink Band X4, and a reuse combination for the terminal to report the first information to the network device includes: uplink: Band X1 and Band X3; downlink: Band X1, Band X3, and Band X4.

In an example, possible self-interference includes: uplink Band X1 and Band X3 interfere with downlink Band Xn, and a reuse combination for the terminal to report the first information to the network device includes: uplink: Band X1 and Band X3; downlink: Band X1, Band X3, and Band Xn; and n is a positive integer other than 1 and 3. That is, any frequency band combination having frequency bands greater than 3 Bands may actually be indicated by reusing a frequency band combination with 2 Bands or a frequency band combination with 3 Bands.

In the embodiments of the present disclosure, for a frequency band combination of a plurality of frequency bands supported by the terminal, no additional reporting is needed, and merely the first information corresponding to the frequency band combination having the predetermined number of frequency bands needs to be reported, thereby reducing the overhead of reported information.

It is to be noted that those skilled in the art may understand that the method provided in the embodiments of the present disclosure may be executed independently or executed together with some methods in some embodiments of the present disclosure or some methods in related technologies.

As shown in FIG. 9, an embodiment of the present disclosure provides a method for processing information. The method for processing information is performed by the terminal, and includes step S91.

In step S91, second information sent by the network device is received, where the second information is configured to indicate frequency offset information of a frequency band combination that needs to be reported.

In an example, the terminal receives the second information sent by the network device.

In an example, the second information includes at least one of the following: interference type information, frequency band indication information, or power level information.

In some embodiments of the present disclosure, the first information may be the first information in other embodiments; the interference type information, the frequency band indication information, and the power level information may be the interference type information, the frequency band indication information, and the power level information in other embodiments, respectively.

In the embodiments of the present disclosure, the terminal may receive the second information sent by the network device to be informed of the frequency offset information (at least one of the frequency offset value or the frequency offset range) of the frequency band combination that needs to be reported to the network device, thereby facilitating the terminal to perform accurate reporting and reducing signaling overhead.

In some embodiments, the terminal sends the first information to the network device after receiving the second information.

In some embodiments, sending the first information includes one of the following:
sending, based on the second information including the interference type information, at least one of a frequency offset value, a frequency offset range, frequency band indication information, or power level information of a frequency band combination corresponding to the interference type information;
sending, based on the second information including the frequency band indication information, at least one of a frequency offset value, a frequency offset range, or interference type information of an interfered frequency band indicated by the frequency band indication information; or
sending, based on the second information including the power level information, at least one of a frequency offset value, a frequency offset range, or interference type information of an interfered frequency band interfered by an interfering frequency band indicated by the power level information.

In an example, the terminal receives the second information sent by the network device, where the second information includes the interference type information; and the terminal may send at least one of the following: the interfered frequency band corresponding to the interference type indicated by the interference type information; the frequency offset value corresponding to the interfered frequency band; the frequency offset range corresponding to the interfered frequency band; or the power level corresponding to the interfering frequency band indicated by the interference type information. In an example, the terminal may or may not report the interference type information to the network device.

In an example, the terminal receives the second information sent by the network device, where the second information includes the frequency band indication information; and the terminal may report, to the network device, at least one of the frequency offset value or the frequency offset range of the interfered frequency band indicated by the frequency band indication information. In an example, the terminal may or may not report the frequency band indication information to the network device. In an example, the terminal may also report at least one of the following to the network device: the power level of the interfering frequency band corresponding to the interfered frequency band indicated by the frequency band indication information; or the interference type corresponding to the interfered frequency band.

In an example, the terminal receives the second information sent by the network device, where the second information includes the power level information. The terminal may report the following to the network device: at least one of the frequency offset value or the frequency offset range of the interfered frequency band interfered by the interfering frequency band indicated by the power level information; and interference type information corresponding to the interfering frequency band. In an example, the terminal may or may not report the power level information to the network device. In an example, the terminal may also report at least one of the following to the network device: an interfered frequency band interfered by the interfering frequency band indicated by the power level information; or frequency band indication information corresponding to the interfered frequency band.

In the embodiments of the present disclosure, the terminal may report the first information merely after receiving the second information sent by the network device, so that the terminal can accurately report and save signaling. In addition, the embodiments of the present disclosure provide reporting for a plurality of requirements of the network device, and are adapted to more application scenarios.

It is to be noted that those skilled in the art may understand that the method provided in the embodiments of the present disclosure may be executed independently or executed together with some methods in some embodiments of the present disclosure or some methods in related technologies.

In some embodiments, the second information includes a frequency offset threshold; and sending the first information to the network device includes: sending, based on the frequency offset value being less than the frequency offset threshold, the first information to the network device.

As shown in FIG. 10, an embodiment of the present disclosure provides a method for processing information. The method for processing information is performed by the terminal, and includes step S101.

In step S101, the first information is sent to the network device based on the frequency offset value being less than the frequency offset threshold.

In some embodiments of the present disclosure, the first information may be the first information in other embodiments; the frequency offset value may be the frequency offset value in other embodiments; the interference type information, the frequency band indication information, and the power level information may be the interference type information, the frequency band indication information, and the power level information in other embodiments, respectively.

In an example, the terminal receives the second information, and the second information includes the frequency offset threshold. In an example, the second information may also include at least one of the following: interference type information, frequency band indication information, or power level information.

In an example, the terminal obtains the frequency offset threshold according to a protocol specification. In an example, the protocol specification is a communication protocol specification, or the protocol specification is a protocol specification negotiated between the terminal and the network device.

In the embodiments of the present disclosure, in a case where the frequency offset value is less than the frequency offset threshold, the interference-free region is relatively large, and the network device is relatively more free in scheduling resources, so that the network device may achieve more free scheduling of resources through reporting the frequency offset value by the terminal. In a case where the frequency offset value corresponding to the frequency band combination is less than the frequency offset threshold, the network device may be informed that the performance of the terminal is relatively better.

An embodiment of the present disclosure provides a method for processing information. The method for processing information is performed by the terminal, and includes: determining, based on the frequency offset value being greater than or equal to the frequency offset threshold, not to send the first information to the network device. Therefore, in a case where the frequency offset value of the frequency band combination is usually greater than the frequency offset threshold, the signaling overhead is saved since the terminal merely does not report the first information.

It is to be noted that, in other embodiments, the terminal may also send the first information to the network device based on the frequency offset value being greater than or equal to the frequency offset threshold.

An embodiment of the present disclosure provides a method for processing information. The method for processing information is performed by the terminal, and includes: sending third indication information to the network device, where the third indication information is configured to indicate whether a frequency offset value corresponding to the terminal is less than a frequency offset threshold.

It is to be noted that those skilled in the art may understand that the method provided in the embodiments of the present disclosure may be executed independently or executed together with some methods in some embodiments of the present disclosure or some methods in related technologies.

An embodiment of the present disclosure provides a method for processing information. The method for processing information is performed by the terminal, and includes one of the following:
determining whether a frequency offset value corresponding to at least one interfered frequency band having a highest power level is less than the frequency offset threshold;
determining whether frequency offset values corresponding to all interference types in interfering frequency bands having a highest power level are less than the frequency offset threshold;
determining, based on the second information further including interference type information, whether a frequency offset value corresponding to the interference type information in interfering frequency bands having a highest power level is less than the frequency offset threshold;
determining, based on the second information further including frequency band indication information, whether a frequency offset value corresponding to an interfered frequency band indicated by the frequency band indication information in interfered frequency bands interfered by interfering frequency bands having a highest power level is less than the frequency offset threshold;
determining, based on the second information further including power level information, whether frequency offset values corresponding to all interfering frequency bands corresponding to power levels indicated by the power level information are less than the frequency offset threshold; or
determining, based on the second information further including interference type information, frequency band indication information and power level information, whether a frequency offset value corresponding to the interference type information and a frequency offset value corresponding to an interfered frequency band indicated by the frequency band indication information are less than the frequency offset threshold in interfering frequency bands corresponding to power levels indicated by the power level information.

In an example, the terminal obtains the frequency offset threshold included in the second information; the terminal determines the highest power level corresponding to the frequency band combination or determines the highest power level from the received second information; and the terminal determines whether all frequency offset values corresponding to the interfered frequency bands interfered by the interfering frequency band corresponding to the highest power level are less than the frequency offset threshold. In an example, the terminal may determine whether a frequency offset value of at least one interfered frequency band is less than the frequency offset threshold.

In an example, as shown in Table 4, the terminal obtains the frequency offset threshold included in the second information, and the terminal determines whether all the interfering frequency bands among the interfering frequency bands corresponding to the highest power level are lower than the frequency offset threshold.

In an example, as shown in Table 4, the terminal obtains the frequency offset threshold and the interference type information included in the second information; and the terminal determines the interfering frequency band corresponding to the highest power level, and determines whether frequency offset values corresponding to interference types indicated by interference type information corresponding to an interfered frequency band interfered by the interfering frequency band are all less than the frequency offset threshold.

In an example, as shown in Table 4, the terminal obtains the frequency offset threshold and the interference type information included in the second information; and the terminal determines an interfering frequency band corresponding to a highest power level, and determines whether frequency offset values corresponding to all interfered frequency bands indicated by the frequency band indication information among interfered frequency bands interfered by the interfering frequency bands are all less than the frequency offset threshold.

In an example, as shown in Table 4, the terminal obtains the frequency offset threshold and the power level information included in the second information; and the terminal determines an interfering frequency band corresponding to a power level indicated by the power level information, and determines whether the frequency offset values corresponding to the interfered frequency bands interfered by the interfering frequency bands are all less than the frequency offset threshold.

In an example, as shown in Table 4, the terminal obtains the frequency offset threshold, the frequency band indication information, the interference type information, and the power level information included in the second information; and the terminal determines the interfering frequency bands corresponding to the power levels indicated by the power level information, and determines whether the frequency offset values corresponding to all interference types indicated by the interference type information on the interfered frequency bands indicated by the frequency band indication information among the interfered frequency bands corresponding to the interfering frequency bands are all less than the frequency offset threshold.

TABLE 4

| | |
|---|---|
| Frequency offset | Determining whether frequency offset values |
| threshold | corresponding to all interference types on |
| | all interfered frequency bands for a highest |
| | power level are all less than the frequency |
| | offset threshold |
| Frequency offset | Determining whether frequency offset values |
| threshold and | corresponding to all interference types |
| interference | indicated by the interference type information |
| type information | on all interfered frequency bands for a |
| | highest power level are all less than the |
| | frequency offset threshold |
| Frequency offset | Determining whether frequency offset values |
| threshold | corresponding to all interfered frequency bands |
| and frequency | indicated by the frequency band indication |
| band indication | information on all interfered frequency bands |
| information | for a highest power level are all less than |
| | the frequency offset threshold |
| Frequency offset | Determining whether frequency offset values |
| threshold and | corresponding to all interfered frequency bands |
| power level | for a power level are all less than the frequency |
| information | offset threshold |
| Frequency offset | Determining whether frequency offset values |
| threshold, frequency | corresponding to all interference types indicated |
| band indication | by the interference type information and the |
| information, | interfered frequency bands indicated by the |
| interference type | frequency band indication information among |
| information and power | the interfered frequency bands corresponding |
| level information | to the power level are all less than the |
| | frequency offset threshold |

It is to be understood that each element in Table 4 independently exists, and these elements are listed in the same table by way of example, but this does not mean that all elements in the table needs to simultaneously exist as shown in the table. A value of each element is independent of a value of any other element in Table 4. Therefore, those skilled in the art may understand that the value of each element in Table 4 is an independent embodiment.

In the embodiments of the present disclosure, the terminal may accurately determine, according to the received various second information sent by the network device, whether the frequency offset value under the various second information is less than the frequency offset threshold. More application scenarios can be adapted in this way.

It is to be noted that those skilled in the art may understand that the method provided in the embodiments of the present disclosure may be executed independently or executed together with some methods in some embodiments of the present disclosure or some methods in related technologies.

The following method for processing information is performed by a network device, and the description of the method for processing information is similar to the method for processing information performed by the terminal described in the present disclosure. For technical details not disclosed in the embodiments of the method for processing information performed by the network device below, reference may be made to the description of the method for processing information performed by the terminal above. Detailed description is not provided herein.

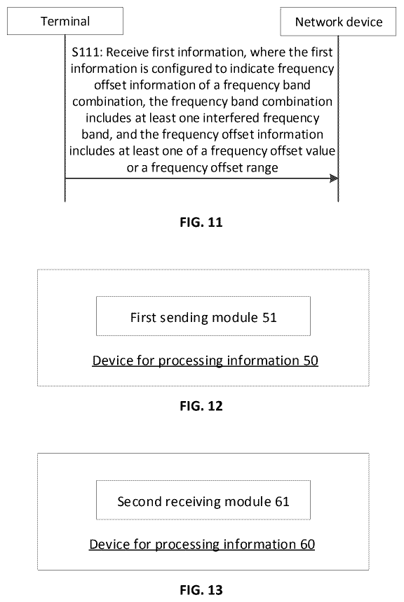

As shown in FIG. 11, an embodiment of the present disclosure provides a method for processing information. The method for processing information is performed by a network device, and includes step S111.

In step S111, first information sent by a terminal is received. The first information is configured to indicate frequency offset information of a frequency band combination, the frequency band combination includes at least one interfered frequency band, and the frequency offset information includes at least one of a frequency offset value or a frequency offset range.

In some embodiments of the present disclosure, the UE and the network device may be the UE and the network device in other embodiments, respectively; the first information may be the first information in other embodiments; and the frequency band combination, the interfered frequency band and the interfering frequency band may be the frequency band combination, the interfered frequency band, and the interfering frequency band in other embodiments, respectively.

In some embodiments, the frequency offset information of the frequency band combination includes at least one of the following:
a frequency offset value of the at least one interfered frequency band in the frequency band combination; or
a frequency offset range of the at least one interfered frequency band in the frequency band combination.

In some embodiments, the frequency offset information of the frequency band combination includes at least one of the following:
a frequency offset value of an interference-free region in the interfered frequency band relative to a bandwidth edge of a downlink signal;
a frequency offset range of an interference-free region in the interfered frequency band relative to a bandwidth edge of a downlink signal;
a frequency offset value of an interference-free region in the interfered frequency band relative to a frequency band edge of an interfering frequency band, where the frequency offset value is close to the frequency band edge of the interfering frequency band; or
a frequency offset range of an interference-free region in the interfered frequency band relative to a frequency band edge of an interfering frequency band, where the frequency offset range is close to the frequency band edge of the interfering frequency band.

In some embodiments, the first information further includes one of the following:
interference type information, where the interference type information is configured to indicate an interference type corresponding to the frequency band combination;
frequency band indication information, where the frequency band indication information is configured to indicate the at least one interfered frequency band included in the frequency band combination; or
power level information, where the power level information is configured to indicate a power level corresponding to an interfering frequency band.

In some embodiments, the interference type information includes one of the following:
first interference type information configured to indicate at least one of a second interference type of a predetermined order or a first interference type, where the first interference type includes at least one of a harmonic interference type, a harmonic mixing interference type, or an adjacent-channel interference type, the second interference type includes an intermodulation interference type, and the predetermined order is greater than or equal to 1; or
second interference type information configured to indicate at least one of the first interference type or the second interference type.

In some embodiments, receiving the first information sent by the terminal includes at least one of the following:
receiving first information sent by the terminal and corresponding to an intermodulation interference type of a lowest order; or
receiving first information sent by the terminal and corresponding to an interfering frequency band having a maximum power level.

An embodiment of the present disclosure provides a method for processing information. The method for processing information is performed by the network device, and includes: receiving first information sent by the terminal and corresponding to an intermodulation interference type of a lowest order; and/or receiving first information sent by the terminal and corresponding to an interfering frequency band having a maximum power level.

In some embodiments, receiving the first information sent by the terminal includes at least one of the following:
receiving first information reported by the terminal for each of different interfered frequency bands;
receiving first information reported by the terminal for each of different interference types; or
receiving first information reported by the terminal for each of different power levels.

An embodiment of the present disclosure provides a method for processing information. The method for processing information is performed by the network device, and includes: receiving first information reported by the terminal for each of different interfered frequency bands; and/or, receiving first information reported by the terminal for each of different interference types; and/or, receiving first information reported by the terminal for each of different power levels.

In some embodiments, the first information includes the frequency offset information, and the first information does not include at least one of interference type information, frequency band indication information, or power level information; and the first information is configured to indicate frequency offset information corresponding to at least one of all interfered frequency bands, all interference types, or all power levels in the frequency band combination.

An embodiment of the present disclosure provides a method for processing information. The method for processing information is performed by the network device, and includes: sending second information to the terminal, where the second information is configured to indicate frequency offset information of a frequency band combination that needs to be reported.

In some embodiments, the second information includes at least one of the following: interference type information, frequency band indication information, or power level information.

In some embodiments, the second information includes interference type information; and receiving the first information sent by the terminal includes: receiving at least one of a frequency offset value, a frequency offset range, frequency band indication information, or power level information, sent by the terminal, of a frequency band combination corresponding to the interference type information.

An embodiment of the present disclosure provides a method for processing information. The method for processing information is performed by the network device, and includes: receiving at least one of a frequency offset value, a frequency offset range, frequency band indication information, or power level information, sent by the terminal, of a frequency band combination corresponding to the interference type information.

In some embodiments, the second information includes frequency band indication information; and receiving the first information sent by the terminal includes: receiving at least one of a frequency offset value, a frequency offset range, or interference type information, sent by the terminal, of an interfered frequency band indicated by the frequency band indication information.

An embodiment of the present disclosure provides a method for processing information The method for processing information is performed by the network device, and includes: receiving at least one of a frequency offset value, a frequency offset range, or interference type information, sent by the terminal, of an interfered frequency band indicated by the frequency band indication information.

In some embodiments, the second information includes power level information; and receiving the first information sent by the terminal includes: receiving at least one of a frequency offset value, a frequency offset range, or interference type information, sent by the terminal, of an interfered frequency band interfered by an interfering frequency band indicated by the power level information.

An embodiment of the present disclosure provides a method for processing information The method for processing information is performed by the network device, and includes: receiving at least one of a frequency offset value, a frequency offset range, or interference type information, sent by the terminal, of an interfered frequency band interfered by an interfering frequency band indicated by the power level information.

In some embodiments, the second information includes a frequency offset threshold; and the frequency offset threshold is configured to enable the terminal to send the first information in a case where the frequency offset threshold is greater than or equal to the frequency offset value.

An embodiment of the present disclosure provides a method for processing information The method for processing information is performed by the network device, and includes: determining, based on the first information, a frequency band for sending a downlink signal.

In an example, the network device determines the frequency offset value based on the first information; and determines, based on the interfering frequency band and the frequency offset value, a frequency band for transmitting a downlink signal.

In an example, the network device determines the frequency offset range based on the first information; and determines, based on the frequency offset value and one of a maximum value, a minimum value, or an average value of the frequency offset range, a frequency band for transmitting a downlink signal.

In an example, the network device determines an interference-free region in the frequency band combination based on the first information, and determines the interference-free region as a frequency band for transmitting a signal.

In this way, the network device may determine that scheduled resources fall within the interference-free region as much as possible to reduce the impact of the self-interference.

The foregoing embodiments may specifically refer to the descriptions on the terminal. Details are not repeated here.

It is to be noted that those skilled in the art may understand that the method provided in the embodiments of the present disclosure may be executed independently or executed together with some methods in some embodiments of the present disclosure or some methods in related technologies.

To further explain any embodiment of the present disclosure, a specific embodiment is provided below.

### Example 1

The method for processing information according to the embodiment of the present disclosure includes: reporting, by a terminal, frequency offset information for self-interference to a base station. In an example, the frequency offset information for the self-interference may be the first information in other embodiments.

In some embodiments, the terminal reports capability information of a self-interference frequency offset capability of a frequency band combination to the base station, where the reported capability information includes at least one of the following: a frequency offset value, interfered frequency band indication, an interference type, or a power level. In an example, the capability information may be the first information in other embodiments.

In an example, the frequency offset value, excluding adjacent-channel interference, refers to a frequency offset value relative to an edge of a bandwidth of an interfered signal. For the adjacent-channel interference, the frequency offset value refers to a frequency offset value relative to an edge of a frequency band where the interfered signal is located, and this frequency band edge is closest to the interfering frequency band. For example, the frequency offset value (foffset) is as shown in FIGS. 2 to 5.

In an example, the unit of the frequency offset value may be in MHz, or may be in units of the size of occupied RBs.

In an example, the frequency offset range may be indicated by 2 bits. For example, different frequency offset ranges may be indicated by the 2 bits in Table 1 of other embodiments.

In an example, the interference type may be indicated by 3 bits in Table 2 of other embodiments.

In an example, the interference type may be indicated by 2 bits in Table 3 of other embodiments.

In some embodiments, for the intermodulation interference type, the corresponding order is not distinguished, and in a case where the frequency band combination has a plurality of intermodulation interferences, merely frequency offset information of a lowest order needs to be reported.

In some embodiments, the interfered frequency band may be indicated by 2 bits. For example, the indication arranged according to the frequency band numbers is 0, 1, and/or 2.

In some embodiments, in a case where a number of supported frequency bands of a frequency band combination is greater than 3, no additional reporting is required, and reference may be made to the frequency offset information in the fallback mode for the case including 3 frequency bands.

In an example, in a case where the terminal reports the following frequency band combination: uplink: Band X1+Band X3; downlink: Band X1+Band X2+Band X3+Band X4, the terminal determines the interfered frequency bands by merely considering the interfered frequency bands in the following fallback modes: uplink: Band X1+Band X3; downlink: Band X1+Band X2+Band X3, Band X1+Band X3+Band X4.

In some embodiments, in a case where the frequency band combination includes a plurality of interfered frequency bands, reporting is needed separately for different interfered frequency bands.

In some embodiments, in a case where the frequency band combination includes a plurality of interference types, reporting is needed separately for different interference types.

In some embodiments, in a case where the terminal supports a plurality of power levels in a certain frequency band combination, merely frequency offset information corresponding to the maximum power level needs to be reported. In an example, the frequency offset information is reported separately according to different power levels, for example, by indicating different power levels with 2 bits.

In some embodiments, in a case where the frequency offset information includes merely the frequency offset value, that is, does not include information such as the interference type, the interfered frequency band, or the power level, this frequency offset value may be considered applicable to at least one of all interference types, all interfered frequency bands, or all power levels.

For the embodiments, reference may be made to expressions of embodiments of at least one of the terminal or the network device. Details are not described herein again.

It is to be noted that those skilled in the art may understand that the method provided in the embodiments of the present disclosure may be executed independently or executed together with some methods in some embodiments of the present disclosure or some methods in related technologies.

### Example 2

In some embodiments, in order to reduce signaling overhead of reporting of the terminal, the terminal reports merely according to notification information from the base station. The notification information from the base station can include at least one of an interfered frequency band, an interference type, or a power level.

In an example, the terminal reports a corresponding frequency offset value according to the received notification information. In this case, the reported frequency offset value does not need to include at least one of the interfered frequency band, the interference type, or the power level.

In an example, the notification information may be the second information of other embodiment.

For the embodiments, reference may be made to expressions of embodiments of at least one of the terminal or the network device. Details are not described herein again.

It is to be noted that those skilled in the art may understand that the method provided in the embodiments of the present disclosure may be executed independently or executed together with some methods in some embodiments of the present disclosure or some methods in related technologies.

### Example 3

In some embodiments, the terminal reports the frequency offset information merely according to notification information from the base station. In an example, the notification information may be the second information in other embodiments; and the frequency offset information may be the first information in other embodiments.

In an example, the notification information includes at least one of the following: the frequency offset threshold, the interfered frequency band, the interference type, or the power level.

In an example, the terminal determines the interfered frequency band based on the received notification information; the terminal determines whether the frequency offset value under this condition (i.e., the interfered frequency band) is below the frequency offset threshold issued by the base station; in a case where the frequency offset value is less than the frequency offset threshold issued by the base station, the frequency offset value is reported. For example, reporting of the frequency offset value can be as shown in Table 4 of other embodiments.

For the embodiments, reference may be made to expressions of embodiments of at least one of the terminal or the network device. Details are not described herein again.

It is to be noted that those skilled in the art may understand that the method provided in the embodiments of the present disclosure may be executed independently or executed together with some methods in some embodiments of the present disclosure or some methods in related technologies.

### Example 4

An embodiment of the present disclosure provides a method for processing information, performed by a communication device. The communication device includes a network device and a UE. The method for processing information includes: sending, by the terminal, first information to the network device, where the first information is configured to indicate frequency offset information of a frequency band combination, the frequency band combination includes at least one interfered frequency band, and the frequency offset information includes at least one of a frequency offset value or a frequency offset range.

In some embodiments, the network device determines, based on the first information, a frequency band for sending a downlink signal.

In some embodiments, the first information further includes at least one of the following: interference type information, frequency band indication information, or power level information.

In some embodiments of the present disclosure, the first information may be the first information in other embodiments; the frequency offset information may be the frequency offset information in other embodiments; the frequency offset value, the frequency offset range, the interference type information, the frequency band indication information, and the power level information may be the frequency offset value, the frequency offset range, the interference type information, the frequency band indication information, and the power level information in other embodiments, respectively.

For the embodiments, reference may be made to expressions of embodiments of at least one of the terminal or the network device. Details are not described herein again.

It is to be noted that those skilled in the art may understand that the method provided in the embodiments of the present disclosure may be executed independently or executed together with some methods in some embodiments of the present disclosure or some methods in related technologies.

### Example 5

An embodiment of the present disclosure provides a method for processing information, performed by a communication device. The communication device includes a network device and a UE. The method for processing information includes: sending, by the network device, second information to the terminal, where the second information is configured to indicate frequency offset information of a frequency band combination that needs to be reported, the frequency band combination includes at least one interfered frequency band, and the frequency offset information includes at least one of a frequency offset value or a frequency offset range; and sending, by the terminal, first information to the network device, where the first information is configured to indicate at least one of the frequency offset value or the frequency offset range of the frequency band combination.

In some embodiments, the second information includes at least one of the following: interference type information, frequency band indication information, or power level information.

In some embodiments, the second information further includes interference type information; and the first information further includes at least one of a frequency offset value, a frequency offset range, frequency band indication information, or power level information of a frequency band combination corresponding to the interference type information.

In some embodiments, the second information further includes frequency band indication information; and the first information further includes at least one of a frequency offset value, a frequency offset range or interference type information of an interfered frequency band indicated by the frequency band indication information.

In some embodiments, the second information further includes power level information; and the first information further includes at least one of a frequency offset value, a frequency offset range, or interference type information of an interfered frequency band interfered by an interfering frequency band indicated by the power level information.

In some embodiments of the present disclosure, the first information and the second information may be the first information and the second information, respectively, in other embodiments; the frequency offset information may be the frequency offset information in other embodiments; the frequency offset value, the frequency offset range, the interference type information, the frequency band indication information, and the power level information may be the frequency offset value, the frequency offset range, the interference type information, the frequency band indication information, and the power level information in other embodiments, respectively.

For the embodiments, reference may be made to expressions of embodiments of at least one of the terminal or the network device. Details are not described herein again.

It is to be noted that those skilled in the art may understand that the method provided in the embodiments of the present disclosure may be executed independently or executed together with some methods in some embodiments of the present disclosure or some methods in related technologies.

### Example 6

An embodiment of the present disclosure provides a method for processing information, performed by a communication device. The communication device includes a network device and a UE. The method for processing information includes: sending, by the network device, second information to the terminal, where the second information is configured to indicate frequency offset information of a frequency band combination that needs to be reported, and the frequency band combination includes at least one interfered frequency band, the frequency offset information includes at least one of a frequency offset value or a frequency offset range, and the second information includes a frequency offset threshold; and sending, by the terminal, first information to the network device based on the frequency offset value being less than the frequency offset threshold, where the first information includes at least one of the frequency offset value or the frequency offset value range.

An embodiment of the present disclosure provides a method for processing information, performed by a communication device. The communication device includes the network device and the UE. The method for processing information further includes: determining, based on the frequency offset value being greater than or equal to the frequency offset threshold, not to send the first information to the network device.

An embodiment of the present disclosure provides a method for processing information, performed by a communication device. The communication device includes the network device and the UE. The method for processing information further includes at least one of the following:
determining whether a frequency offset value corresponding to at least one interfered frequency band having a highest power level is less than the frequency offset threshold;
determining whether frequency offset values corresponding to all interference types in interfering frequency bands having a highest power level are less than the frequency offset threshold;
determining, based on the second information further including interference type information, whether a frequency offset value corresponding to the interference type information in interfering frequency bands having a highest power level is less than the frequency offset threshold;
determining, based on the second information further including frequency band indication information, whether a frequency offset value corresponding to an interfered frequency band indicated by the frequency band indication information in interfered frequency bands interfered by interfering frequency bands having a highest power level is less than the frequency offset threshold;
determining, based on the second information further including power level information, whether frequency offset values corresponding to all interfering frequency bands corresponding to power levels indicated by the power level information are less than the frequency offset threshold; or
determining, based on the second information further including interference type information, frequency band indication information and power level information, whether a frequency offset value corresponding to the interference type information and a frequency offset value corresponding to an interfered frequency band indicated by the frequency band indication information are less than the frequency offset threshold in interfering frequency bands corresponding to power levels indicated by the power level information.

In some embodiments of the present disclosure, the first information and the second information may be the first information and the second information, respectively, in other embodiments; the frequency offset information may be the frequency offset information in other embodiments; the frequency offset value, the frequency offset range, the interference type information, the frequency band indication information, and the power level information may be the frequency offset value, the frequency offset range, the interference type information, the frequency band indication information, and the power level information in other embodiments, respectively.

For the embodiments, reference may be made to expressions of embodiments of at least one of the terminal or the network device. Details are not described herein again.

It is to be noted that those skilled in the art may understand that the method provided in the embodiments of the present disclosure may be executed independently or executed together with some methods in some embodiments of the present disclosure or some methods in related technologies.

As shown in FIG. 12, an embodiment of the present disclosure provides a device for processing information. The device for processing information 50 includes a first sending module 51.

The first sending module 51 is configured to send first information to a network device. The first information is configured to indicate frequency offset information of a frequency band combination, the frequency band combination includes at least one interfered frequency band, and the frequency offset information includes at least one of a frequency offset value or a frequency offset range.

The device for processing information 50 provided in the embodiment of the present disclosure may be a terminal.

In some embodiments, the frequency offset information of the frequency band combination includes at least one of the following:
a frequency offset value of the at least one interfered frequency band in the frequency band combination; or
a frequency offset range of the at least one interfered frequency band in the frequency band combination.

In some embodiments, the frequency offset information of the frequency band combination includes at least one of the following:
a frequency offset value of an interference-free region in the interfered frequency band relative to a bandwidth edge of a downlink signal;
a frequency offset range of an interference-free region in the interfered frequency band relative to a bandwidth edge of a downlink signal;
a frequency offset value of an interference-free region in the interfered frequency band relative to a frequency band edge of an interfering frequency band, where the frequency offset value is close to the frequency band edge of the interfering frequency band; or
a frequency offset range of an interference-free region in the interfered frequency band relative to a frequency band edge of an interfering frequency band, where the frequency offset range is close to the frequency band edge of the interfering frequency band.

In some embodiments, the first information further includes at least one of the following:
interference type information, where the interference type information is configured to indicate an interference type corresponding to the frequency band combination;
frequency band indication information, where the frequency band indication information is configured to indicate the at least one interfered frequency band included in the frequency band combination; or power level information, where the power level information is configured to indicate a power level corresponding to an interfering frequency band.

In some embodiments, the interference type information includes one of the following:
first interference type information configured to indicate at least one of a second interference type of a predetermined order or a first interference type, where the first interference type includes at least one of a harmonic interference type, a harmonic mixing interference type, or an adjacent-channel interference type, the second interference type includes an intermodulation interference type, and the predetermined order is greater than 1; or
second interference type information configured to indicate at least one of the first interference type or the second interference type.

An embodiment of the present disclosure provides the device for processing information 50. The device for processing information 50 includes the first sending module 51. The first sending module 51 is configured to perform at least one of the following:
sending, based on the frequency band combination corresponding to a plurality of intermodulation interference types, first information corresponding to an intermodulation interference type of a lowest order; or
sending, based on interfering frequency bands in the frequency band combination corresponding to a plurality of power levels, first information corresponding to an interfering frequency band having a maximum power level.

An embodiment of the present disclosure provides the device for processing information 50. The device for processing information 50 includes the first sending module 51. The first sending module 51 is configured to perform at least one of the following:
reporting, based on the frequency band combination including a plurality of interfered frequency bands, first information for each of different interfered frequency bands;
reporting, based on the frequency band combination corresponding to a plurality of interference types, first information for each of different interference types; or
reporting, based on interfering frequency bands included in the frequency band combination corresponding to a plurality of power levels, first information for each of different power levels.

In some embodiments, the first information includes the frequency offset information, and the first information does not include at least one of interference type information, frequency band indication information, or power level information; and the first information is configured to indicate frequency offset information corresponding to at least one of all interfered frequency bands, all interference types, or all power levels in the frequency band combination.

An embodiment of the present disclosure provides the device for processing information 50. The device for processing information 50 includes: a first receiving module (not shown) configured to receive second information sent by the network device, where the second information is configured to indicate frequency offset information of a frequency band combination that needs to be reported.

In some embodiments, the second information includes at least one of the following: interference type information, frequency band indication information, or power level information.

An embodiment of the present disclosure provides the device for processing information 50. The device for processing information 50 includes the first sending module 51. The first sending module 51 is configured to perform one of the following:
sending, based on the second information including the interference type information, at least one of a frequency offset value, a frequency offset range, frequency band indication information, or power level information of a frequency band combination corresponding to the interference type information;
sending, based on the second information including the frequency band indication information, at least one of a frequency offset value, a frequency offset range, or interference type information of an interfered frequency band indicated by the frequency band indication information; or
sending, based on the second information including the power level information, at least one of a frequency offset value, a frequency offset range, or interference type information of an interfered frequency band interfered by an interfering frequency band indicated by the power level information.

In some embodiments, the second information includes a frequency offset threshold.

The device for processing information 50 according to the embodiment of the present disclosure includes the first sending module 51. The first sending module 51 is configured to send, based on the frequency offset value being less than the frequency offset threshold, the first information to the network device.

The device for processing information 50 according to the embodiment of the present disclosure includes: a first processing module (not shown) configured to determine, based on the frequency offset value being greater than or equal to the frequency offset threshold, not to send the first information to the network device.

The device for processing information 50 according to the embodiment of the present disclosure includes: the first processing module configured to perform one of the following:
determining whether a frequency offset value corresponding to at least one interfered frequency band having a highest power level is less than the frequency offset threshold;
determining whether frequency offset values corresponding to all interference types in interfering frequency bands having a highest power level are less than the frequency offset threshold;
determining, based on the second information further including interference type information, whether a frequency offset value corresponding to the interference type information in interfering frequency bands having a highest power level is less than the frequency offset threshold;
determining, based on the second information further including frequency band indication information, whether a frequency offset value corresponding to an interfered frequency band indicated by the frequency band indication information in interfered frequency bands interfered by interfering frequency bands having a highest power level is less than the frequency offset threshold;
determining, based on the second information further including power level information, whether frequency offset values corresponding to all interfering frequency bands corresponding to power levels indicated by the power level information are less than the frequency offset threshold; or
determining, based on the second information further including interference type information, frequency band indication information and power level information, whether a frequency offset value corresponding to the interference type information and a frequency offset value corresponding to an interfered frequency band indicated by the frequency band indication information are less than the frequency offset threshold in interfering frequency bands corresponding to power levels indicated by the power level information.

As shown in FIG. 13, an embodiment of the present disclosure provides a device for processing information. The device for processing information 60 includes a second receiving module 61.

The second receiving module 61 is configured to receive first information sent by a terminal, where the first information is configured to indicate frequency offset information of a frequency band combination, the frequency band combination includes at least one interfered frequency band, and the frequency offset information includes at least one of a frequency offset value or a frequency offset range.

The device for processing information 60 provided in the embodiment of the present disclosure may be a network device.

In some embodiments, the frequency offset information of the frequency band combination includes at least one of the following:
a frequency offset value of the at least one interfered frequency band in the frequency band combination; or
a frequency offset range of the at least one interfered frequency band in the frequency band combination.

In some embodiments, the frequency offset information of the frequency band combination includes at least one of the following:
a frequency offset value of an interference-free region in the interfered frequency band relative to a bandwidth edge of a downlink signal;
a frequency offset range of an interference-free region in the interfered frequency band relative to a bandwidth edge of a downlink signal;
a frequency offset value of an interference-free region in the interfered frequency band relative to a frequency band edge of an interfering frequency band, where the frequency offset value is close to the frequency band edge of the interfering frequency band; or
a frequency offset range of an interference-free region in the interfered frequency band relative to a frequency band edge of an interfering frequency band, where the frequency offset range is close to the frequency band edge of the interfering frequency band.

In some embodiments, the first information further includes one of the following:
interference type information, where the interference type information is configured to indicate an interference type corresponding to the frequency band combination;
frequency band indication information, where the frequency band indication information is configured to indicate the at least one interfered frequency band included in the frequency band combination; or
power level information, where the power level information is configured to indicate a power level corresponding to an interfering frequency band.

In some embodiments, the interference type information includes one of the following:
first interference type information configured to indicate at least one of a second interference type of a predetermined order or a first interference type, where the first interference type includes at least one of a harmonic interference type, a harmonic mixing interference type, or an adjacent-channel interference type, the second interference type includes an intermodulation interference type, and the predetermined order is greater than or equal to 1; or
second interference type information configured to indicate at least one of the first interference type or the second interference type.

An embodiment of the present disclosure provides the device for processing information 60. The device for processing information 60 includes: the second receiving module 61 configured to perform at least one of the following:
receiving first information sent by the terminal and corresponding to an intermodulation interference type of a lowest order; or
receiving first information sent by the terminal and corresponding to an interfering frequency band having a maximum power level.

An embodiment of the present disclosure provides the device for processing information 60. The device for processing information 60 includes: the second receiving module 61 configured to perform at least one of the following:
receiving first information reported by the terminal for each of different interfered frequency bands;
receiving first information reported by the terminal for each of different interference types; or
receiving first information reported by the terminal for each of different power levels.

In some embodiments, the first information includes the frequency offset information, and the first information does not include at least one of interference type information, frequency band indication information, or power level information; and the first information is configured to indicate frequency offset information corresponding to at least one of all interfered frequency bands, all interference types, or all power levels in the frequency band combination.

An embodiment of the present disclosure provides the device for processing information 60. The device for processing information 60 includes: a second sending module (not shown) configured to send second information to the terminal, where the second information is configured to indicate frequency offset information of a frequency band combination that needs to be reported.

In some embodiments, the second information includes at least one of the following: interference type information, frequency band indication information, or power level information.

In some embodiments, the second information includes interference type information.

An embodiment of the present disclosure provides the device for processing information 60. The device for processing information 60 includes: the second receiving module 61 configured to receive at least one of a frequency offset value, a frequency offset range, frequency band indication information, or power level information, sent by the terminal, of a frequency band combination corresponding to the interference type information.

In some embodiments, the second information includes frequency band indication information.

An embodiment of the present disclosure provides the device for processing information 60. The device for processing information 60 includes: the second receiving module 61 configured to receive at least one of a frequency offset value, a frequency offset range, or interference type information, sent by the terminal, of an interfered frequency band indicated by the frequency band indication information.

In some embodiments, the second information includes power level information.

An embodiment of the present disclosure provides the device for processing information 60. The device for processing information 60 includes: the second receiving module 61 configured to receive at least one of a frequency offset value, a frequency offset range, or interference type information, sent by the terminal, of an interfered frequency band interfered by an interfering frequency band indicated by the power level information.

In some embodiments, the second information includes a frequency offset threshold, and the frequency offset threshold is configured to enable the terminal to send the first information in a case where the frequency offset threshold is greater than or equal to the frequency offset value.

An embodiment of the present disclosure provides the device for processing information 60. The device for processing information 60 includes: a second processing module (not shown) configured to determine, based on the first information, a frequency band for sending a downlink signal.

It is to be noted that those skilled in the art may understand that the device provided in the embodiments of the present disclosure may be executed independently or executed together with some devices in some embodiments of the present disclosure or some devices in related technologies.

For the device in the embodiments, specific manners of performing operations by each module are described in detail in embodiments related to the method, and details are not described herein.

An embodiment of the present disclosure provides a communication device (not shown). The communication device includes one or more processors, a transceiver, a memory, and an executable program stored on the memory and executable by the one or more processors. The one or more processors, when collectively running the executable program, performs the method for processing information provided in the present disclosure.

In some embodiments, the processor may include various types of storage media. The storage media may be a non-transitory computer-readable storage media capable of retaining information stored thereon after power off of the communication device.

In some embodiments, the communication device includes a terminal or a network device.

The processor may be connected to the memory via a bus or the like, for reading the executable program stored in the memory, for example, at least one of the methods shown in FIGS. 6 to 11.

An embodiment of the present disclosure provides a non-transitory computer-readable storage medium. The non-transitory computer-readable storage medium stores an executable program. The executable program, when collectively executed by one or more processors, implements the method for processing information provided in the present disclosure, for example, at least one of the methods shown in FIGS. 6 to 11.

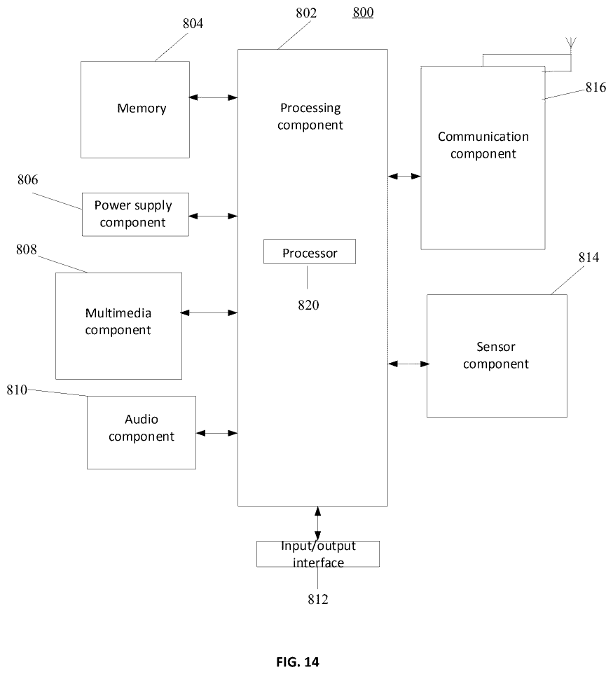

FIG. 14 is a block diagram of a terminal 800 according to an example. For example, the terminal 800 may be a mobile phone, a computer, a digital broadcast user device, a messaging device, a game console, a tablet device, a medical device, an exercise device, a personal digital assistant, and the like.

Referring to FIG. 14, the terminal 800 may include one or more of the following components: a processing component 802, a memory 804, a power supply component 806, a multimedia component 808, an audio component 810, an input/output (I/O) interface 812, a sensor component 814, and a communication component 816.

The processing component 802 generally controls the overall operation of the terminal 800, such as operations associated with display, telephone calls, data communications, camera operations, and recording operations. The processing component 802 may include one or more processors 820 to execute instructions to generate all or part of the steps of the methods described in the present disclosure. In addition, the processing component 802 may include one or more modules to facilitate interaction between the processing component 802 and other components. For example, the processing component 802 may include a multimedia module to facilitate interaction between the multimedia component 808 and the processing component 802.

The memory 804 is configured to store various types of data to support operations at the terminal 800. Examples of such data include instructions for any application or method operating on the terminal 800, contact data, address book data, messages, pictures, videos, and the like. The memory 804 may be implemented by any type of volatile or non-volatile storage device or a combination of these devices, for example, a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disc.

The power supply component 806 provides power to the various components of the terminal 800. The power supply component 806 may include a power supply management system, one or more power supplies, and other components associated with generating, managing, and distributing power to the terminal 800.

The multimedia component 808 includes a screen that provides an output interface between the terminal 800 and a user. In some embodiments, the screen may include a liquid crystal display (LCD) and a touch panel (TP). If the screen includes a touch panel, the screen may be implemented as a touch screen to receive an input signal from a user. The touch panel includes one or more touch sensors to sense touching, sliding, and a gesture on the touch panel. The touch sensor may not only sense a boundary of a touch action or a slide action, but also detect duration and a pressure related to the touch operation or the slide operation. In some embodiments, the multimedia component 808 includes at least one of a front-facing camera or a rear-facing camera. The front-facing camera and/or the rear-facing camera may receive external multimedia data in a case that the terminal 800 is in an operating mode, such as a photographing mode or a video mode. Each of the front-facing camera and the rear-facing camera may be a fixed optical lens system that has a focal length and an optical zoom capability.

The audio component 810 is configured to output and/or input an audio signal. For example, the audio component 810 may include a microphone (MIC), and the microphone is configured to receive external audio signals in a case where the terminal 800 is in an operation mode, such as a call mode, a recording mode, and a voice recognition mode. The received audio signal may further be stored in the memory 804 or sent via the communication component 816. In some embodiments, the audio component 810 further includes a speaker configured to output an audio signal.

The I/O interface 812 provides an interface between the processing component 802 and a peripheral interface module. The peripheral interface module may be a keyboard, a click wheel, a button, and the like. These buttons may include, but are not limited to: a home button, a volume button, a start button, and a lock button.

The sensor component 814 includes one or more sensors configured to provide status evaluation in various aspects for the terminal 800. For example, the sensor component 814 can detect the open/closed state of the terminal 800, and the relative positioning of components such as a display and keypad of the terminal 800. The sensor component 814 can also detect a change in the position of the terminal 800 or a component of the terminal 800, the presence or absence of user contact with the terminal 800, an orientation or acceleration/deceleration of the terminal 800, and a change in the temperature of the terminal 800. The sensor component 814 may include a proximity sensor configured to detect the presence of a nearby object in the absence of any physical contact. The sensor component 814 may further include an optical sensor, such as a Complementary Metal-Oxide-Semiconductor (CMOS) or Charge Coupled Device (CCD) image sensor, configured to be used in an imaging application. In some embodiments, the sensor component 814 may further include an acceleration sensor, a gyroscope sensor, a magnetic sensor, a pressure sensor, or a temperature sensor.

The communication component 816 is configured to facilitate a wired or wireless communication between the terminal 800 and other devices. The terminal 800 may access a wireless network based on a communication standard, such as Wi-Fi, 2G, or 3G, or a combination of the Wi-Fi, 2G and 3G. In an example, the communication component 816 receives a broadcast signal or broadcast associated information from an external broadcast management system via a broadcast channel. In an example, the communication component 816 further includes a near field communication (NFC) module to facilitate short range communications. For example, the NFC module may be implemented based on radio frequency identification (RFID) technology, infrared data association (IrDA) technology, ultra-wideband (UWB) technology, Bluetooth (BT) technology, and other technologies.

In an example, the terminal 800 may be implemented by one or more application specific integrated circuits (ASICs), digital signal processors (DSPs), digital signal processing devices (DSPDs), programmable logic devices (PLDs), field programmable gate arrays (FPGAs), controllers, micro-controller units, microprocessors, or other electronic components, and is configured to perform the methods described in the present disclosure.

In an example, an embodiment of the present disclosure further provides a non-transitory computer-readable storage medium including instructions, such as the memory 804 including instructions, where the instructions are executable by the processor 820 of the terminal 800 to generate the methods described in the present disclosure. For example, the non-transitory computer-readable storage medium may be a ROM, a random access memory (RAM), a Compact Disc Read-Only Memory (CD-ROM), a magnetic tape, a floppy disk, an optical data storage device, and the like.

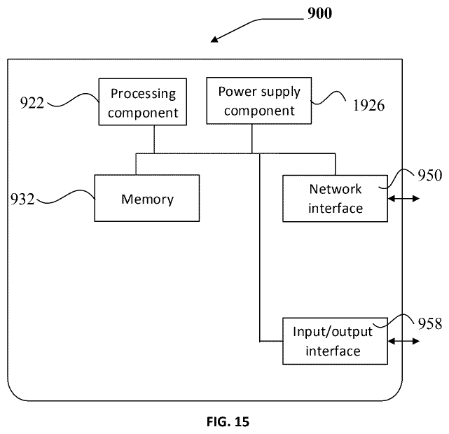

As shown in FIG. 15, an embodiment of the present disclosure shows a structure of a communication device. For example, the communication device 900 can be provided as a network device. The communication device 900 may be any network element such as at least one of the access network element or network function. The communication device 900 may be the terminal or the network device in other embodiments.

Referring to FIG. 15, the communication device 900 includes a processing component 922, which further includes one or more processors, and a memory resource represented by a memory 932, for storing instructions executable by the processing component 922, for example, applications. The applications stored in the memory 932 can include one or more modules, each corresponding to a set of instructions. In addition, the processing component 922 is configured to execute the instructions to perform any of the methods applied to the access device as described in the present disclosure.

The communication device 900 may further include a power supply component 926 configured to perform power management of the communication device 900, a wired or wireless network interface 950 configured to connect the communication device 900 to a network, and an input/output (I/O) interface 958. The communication device 900 may operate based on an operating system stored in the memory 932, for example, Windows Server™, Mac OS X™, Unix™, Linux™, FreeBSD™, or the like.

As used herein, the term “processor” may refer to one processor that performs the defined functions or a plurality of processors that collectively perform defined functions, such that the execution of the individual defined functions may be divided amongst such processors.

Without contradiction, each step in an embodiment or example may be implemented as an independent embodiment, and the steps may be combined in any manner. For example, a solution in which some steps are removed in an embodiment or example can also be implemented as an independent embodiment, and the order of the steps in an embodiment or example can be exchanged arbitrarily. In addition, optional manners or optional examples in an embodiment or example can be combined in any manner. Furthermore, different embodiments or examples may be combined in any manner; for example, some or all steps of different embodiments or examples can be combined arbitrarily, and an embodiment or example can be combined with optional manners or optional examples of other embodiments or examples in any manner.

Other embodiments of the present disclosure will be apparent to those skilled in the art based on the specification and practice of the present disclosure disclosed herein. The present disclosure is intended to cover any variations, uses or adaptive changes of the present disclosure that follow the general principles of the present disclosure and comprise common general knowledge and conventional technical means that are within the art to which the present disclosure pertains and are not disclosed in the present disclosure. The specification and embodiments are merely considered as example, with a true scope and spirit of the present disclosure being indicated by the following claims.

It is to be understood that the present disclosure is not limited to the precise arrangements that have been described above and shown in the drawings, and that various modifications and changes can be made without departing from the scope of the present disclosure. The scope of the present disclosure is limited merely by the appended claims.

1. A method for processing information, performed by a terminal, the method comprising:
sending first information to a network device, wherein the first information is configured to indicate frequency offset information of a frequency band combination, the frequency band combination comprises at least one interfered frequency band, and the frequency offset information comprises at least one of a frequency offset value or a frequency offset range.

2. The method according to claim 1, wherein the frequency offset information of the frequency band combination comprises at least one of the following:
a frequency offset value of the at least one interfered frequency band in the frequency band combination; or
a frequency offset range of the at least one interfered frequency band in the frequency band combination.

3. The method according to claim 1, wherein the frequency offset information of the frequency band combination comprises at least one of the following:
a frequency offset value of an interference-free region in the at least one interfered frequency band relative to a bandwidth edge of a downlink signal;
a frequency offset range of an interference-free region in the at least one interfered frequency band relative to a bandwidth edge of a downlink signal;
a frequency offset value of an interference-free region in the at least one interfered frequency band relative to a frequency band edge of an interfering frequency band, wherein the frequency offset value is close to the frequency band edge of the interfering frequency band; or
a frequency offset range of an interference-free region in the at least one interfered frequency band relative to a frequency band edge of an interfering frequency band, wherein the frequency offset range is close to the frequency band edge of the interfering frequency band.

4. The method according to claim 1, wherein the first information further comprises at least one of the following:
interference type information, wherein the interference type information is configured to indicate an interference type corresponding to the frequency band combination;
frequency band indication information, wherein the frequency band indication information is configured to indicate the at least one interfered frequency band comprised in the frequency band combination; or
power level information, wherein the power level information is configured to indicate a power level corresponding to an interfering frequency band.

5. The method according to claim 4, wherein the interference type information comprises one of the following:
first interference type information configured to indicate at least one of a second interference type of a predetermined order or a first interference type, wherein the first interference type comprises at least one of a harmonic interference type, a harmonic mixing interference type, or an adjacent-channel interference type, the second interference type comprises an intermodulation interference type, and the predetermined order is greater than 1; or
second interference type information configured to indicate at least one of the first interference type or the second interference type.

6. The method according to claim 4, wherein sending the first information comprises at least one of the following:
sending, based on the frequency band combination corresponding to a plurality of intermodulation interference types, first information corresponding to an intermodulation interference type of a lowest order; or
sending, based on the interfering frequency bands in the frequency band combination corresponding to a plurality of power levels, first information corresponding to an interfering frequency band having a maximum power level.

7. The method according to claim 4, wherein sending the first information comprises at least one of the following:
reporting, based on the frequency band combination comprising a plurality of interfered frequency bands, first information for each of different interfered frequency bands;
reporting, based on the frequency band combination corresponding to a plurality of interference types, first information for each of different interference types; or
reporting, based on the interfering frequency bands comprised in the frequency band combination corresponding to a plurality of power levels, first information for each of different power levels.

8. The method according to claim 1, wherein
the first information comprises the frequency offset information, and the first information does not comprise at least one of interference type information, frequency band indication information, or power level information; and the first information is configured to indicate frequency offset information corresponding to at least one of all interfered frequency bands, all interference types, or all power levels in the frequency band combination.

9. The method according to claim 1, wherein the method further comprises:
receiving second information sent by the network device, wherein the second information is configured to indicate frequency offset information of a frequency band combination that needs to be reported.

10. The method according to claim 9, wherein the second information comprises at least one of the following:
interference type information, frequency band indication information, or power level information.

11. The method according to claim 9, wherein sending the first information comprises one of the following:
sending, based on the second information comprising interference type information, at least one of a frequency offset value, a frequency offset range, frequency band indication information, or power level information of a frequency band combination corresponding to the interference type information;
sending, based on the second information comprising frequency band indication information, at least one of a frequency offset value, a frequency offset range, or interference type information of an interfered frequency band indicated by the frequency band indication information; or
sending, based on the second information comprising power level information, at least one of a frequency offset value, a frequency offset range, or interference type information of an interfered frequency band interfered by an interfering frequency band indicated by the power level information.

12. The method according to claim 9, wherein the second information comprises a frequency offset threshold; and
sending the first information to the network device comprises: sending, based on the frequency offset value being less than the frequency offset threshold, the first information to the network device.

13. The method according to claim 12, wherein the method further comprises:
determining, based on the frequency offset value being greater than or equal to the frequency offset threshold, not to send the first information to the network device.

14. The method according to claim 12, wherein the method further comprises one of the following:
determining whether a frequency offset value corresponding to at least one interfered frequency band having a highest power level is less than the frequency offset threshold;
determining whether frequency offset values corresponding to all interference types in interfering frequency bands having a highest power level are less than the frequency offset threshold;
determining, based on the second information further comprising interference type information, whether a frequency offset value corresponding to the interference type information in interfering frequency bands having a highest power level is less than the frequency offset threshold;
determining, based on the second information further comprising frequency band indication information, whether a frequency offset value corresponding to an interfered frequency band indicated by the frequency band indication information in interfered frequency bands interfered by interfering frequency bands having a highest power level is less than the frequency offset threshold;
determining, based on the second information further comprising power level information, whether frequency offset values corresponding to all interfering frequency bands corresponding to power levels indicated by the power level information are less than the frequency offset threshold; or
determining, based on the second information further comprising interference type information, frequency band indication information and power level information, whether a frequency offset value corresponding to the interference type information and a frequency offset value corresponding to an interfered frequency band indicated by the frequency band indication information are less than the frequency offset threshold in interfering frequency bands corresponding to power levels indicated by the power level information.

15. A method for processing information, performed by a network device, the method comprising:
receiving first information sent by a terminal, wherein the first information is configured to indicate frequency offset information of a frequency band combination, the frequency band combination comprises at least one interfered frequency band, and the frequency offset information comprises at least one of a frequency offset value or a frequency offset range.

16. The method according to claim 15, wherein the frequency offset information of the frequency band combination comprises at least one of the following:
a frequency offset value of the at least one interfered frequency band in the frequency band combination; or
a frequency offset range of the at least one interfered frequency band in the frequency band combination.

17. The method according to claim 15, wherein the frequency offset information of the frequency band combination comprises at least one of the following:
a frequency offset value of an interference-free region in the at least one interfered frequency band relative to a bandwidth edge of a downlink signal;
a frequency offset range of an interference-free region in the at least one interfered frequency band relative to a bandwidth edge of a downlink signal;
a frequency offset value of an interference-free region in the at least one interfered frequency band relative to a frequency band edge of an interfering frequency band, wherein the frequency offset value is close to the frequency band edge of the interfering frequency band; or
a frequency offset range of an interference-free region in the at least one interfered frequency band relative to a frequency band edge of an interfering frequency band, wherein the frequency offset range is close to the frequency band edge of the interfering frequency band.

18. The method according to claim 15, wherein the first information further comprises one of the following:
interference type information, wherein the interference type information is configured to indicate an interference type corresponding to the frequency band combination;
frequency band indication information, wherein the frequency band indication information is configured to indicate the at least one interfered frequency band comprised in the frequency band combination; or
power level information, wherein the power level information is configured to indicate a power level corresponding to an interfering frequency band.

19-31. (canceled)

32. A terminal, comprising:
one or more processors;
a transceiver;
a memory storing a processor-executable program;
wherein the processor-executable program, when executed by the one or more processors, causes the terminal to:
send first information to a network device, wherein the first information is configured to indicate frequency offset information of a frequency band combination, the frequency band combination comprises at least one interfered frequency band, and the frequency offset information comprises at least one of a frequency offset value or a frequency offset range.

33. (canceled)

34. A network device, comprising:
one or more processors;
a transceiver; and
a memory storing a processor-executable program;
wherein the processor-executable program, when executed by the one or more processors, causes the network device to perform the method according to claim 15.
